(19) United States
(12) Patent Application Publication
(10) Pub. No.: US 2007/0257860 A1
(43) Pub. Date: Nov. 8, 2007

(54) SYSTEM AND METHOD FOR DRIVING BI-COLOR LED

(76) Inventor: Tamir Langer, Givataim (IL)

Correspondence Address: POWERDSINE LTD., C/O LANDONIP, INC, 1700 DIAGONAL ROAD, SUITE 450, ALEXANDRIA, VA, 22314-2866, US

(21) Appl. No.: 11/381,538

(22) Filed: May 4, 2006

(51) Int. Cl. G09G 3/14

(52) U.S. Cl. 345/46

(57) ABSTRACT

A method of driving LED pairs comprising: providing a plurality of LED pairs each exhibiting a parallel reverse anode to cathode arrangement and each comprising a first LED and a second LED; receiving a time varying electrical signal commonly at the anode of the first LED of each of the LED pairs; and individually driving the anode of the second LED each of the provided LED pairs to one of a high value and a low value, wherein the received time varying electrical signal exhibits a high value operative to illuminate the first LED of each of the LED pairs when the anode of the second LED is driven to a low level, and a low voltage level operative to light the second LED of each of the LED pairs when the anode of the second LED is driven to a high level.

### BACKGROUND OF THE INVENTION

The present invention relates to a system and method for driving bicolor light emitting diodes and more particularly to a system and method for driving a plurality of pairs of reverse connected light emitting diodes utilizing a time varying signal exhibiting a common connection to all the bicolor light emitting diodes and a unique connection for each pair, the unique connection exhibiting at least a high and a low state.

Bicolor light emitting diode (LED) assemblies are often used as indicators. Advantageously, LEDs are available in a plurality of colors, allowing for the display of information using a color code. The electrical characteristics of different color LEDs are different, and thus different driving voltages and currents may be required for each color LED. For example, in the case of power over Ethernet, a green illuminated LED is indicative of a port being powered, a red illuminated LED is indicative of an overload and a flashing red LED is indicative of a short circuit. Advantageously, both the green and red LEDs are supplied as a single assembly and viewed through a single window or lens, thus saving on panel space. One or both of the LEDs of the bicolor LED assembly may also be flashed to indicate yet another condition.

U.S. patent application Ser. No. 10/334,386 filed Dec. 31, 2002 entitled “Integral Board and Module for Power Over LAN”, whose entire contents are incorporated herein by reference, is addressed to an apparatus for supplying power within a local area network. A switch board comprising support circuitry is supplied separately from a module comprising the power supply and power distribution and control circuitry.

U.S. patent application Ser. No. 11/261,705 filed Oct. 31, 2005 entitled “SYSTEM FOR PROVIDING POWER OVER ETHERNET THROUGH A PATCH PANEL”, whose entire contents are incorporated herein by reference, is addressed to a power ready patch panel arranged to receive a plurality of current controlled signals from a separate power sourcing device. In one embodiment the power ready patch panel comprises a status indicator for each port of the power ready patch panel, the status indicator being driven from the power sourcing device. For a power ready patch panel supporting a large plurality of ports, connections for each of the status indicator is required.

It would be desirable to support indicator LEDs showing the status of each powered port. Such indicator LEDs, which are preferably constituted of a plurality of bi-color LED assemblies, with a specific bi-color LED assembly being associated with each port, may be supplied as part of the switch board in the case of U.S. patent application Ser. No. 10/334,386, or as part of the power ready patch panel in the case of U.S. patent application Ser. No. 11/261,705. It is desirable to minimize the number of connections required respectively between the module and the switch board, or power sourcing device and power ready patch panel, to illuminate each of the LEDs in the plurality of bi-color LED assemblies.

U.S. Pat. No. 4,837,565 to White, is addressed to an apparatus for indicating a function status via a bi-color LED assembly. The bi-color LED assemblies are each provided in a parallel reverse connected arrangement, i.e. the cathode of each color LED of the bi-color LED assembly is connected to the anode of the other color LED of the bi-color LED assembly. Each LED to be driven requires two dedicated connections to the driving circuit. Thus, for a large number of bi-color LED assemblies, the number of required connections is twice the number of bi-color LED assemblies.

What is therefore needed, and not known in the prior art, is a means for supplying support for a plurality of bi-color LED assemblies with a minimum number of connections. Preferably the number of connections should be of the order of the number of bi-color LED assemblies.

### SUMMARY OF THE INVENTION

Accordingly, it is a principal object of the present invention to overcome the disadvantages of prior art. This is provided in the present invention by providing a circuit for controllably illuminating a plurality of parallel reverse connected LED pairs via a single specific connection associated with each LED pair, plus a single common connection for all of the LED pairs. In an exemplary embodiment the LED pairs are constituted of a bi-color LED assembly. The single common connection is connected to a source of a time varying signal, preferably a slew controlled square wave. Each single specific connection is connected to a controllable source, such as a digital TTL level output, which can be controllably set to one of a high level and a low level. Preferably the controllable source further exhibits a high impedance output.

In the event the output of the controllable source associated with a specific LED pair exhibits a low level signal, current is sunk by the controllable source when the time varying signal is high, thereby illuminating a first LED of the LED pair. In the event that the output of the controllable source associated with a specific LED pair exhibits a high level signal, current is sourced by the controllable source when the time varying signal is low, thereby illuminating the second LED of the LED pair. In the event that the output of the controllable source associated with a specific LED pair is set to a high impedance state, neither LED of the LED pair is illuminated.

Preferably, the duty cycle of the time varying signal is set so as to adjust the brightness of the first LED to be similar to the brightness of the second LED thereby compensating for the differing electrical characteristics of the different constituent color LEDs. Preferably, either of the LEDs can be flashed at a controllable rate by controllably switching the controllable source between a high impedance state and a conductive state, while maintaining the time varying input signal.

In one embodiment the bi-color LEDs are green and yellow. In an embodiment in which the bi-color LEDs are meant to display a powering status, in one embodiment green is indicative of a powered port and yellow is indicative that the port can not be powered.

The invention provides for an apparatus for driving a plurality of LED pairs, the apparatus comprising: a plurality of LED pairs, each of the plurality of LED pairs exhibiting a first LED and a second LED in a parallel reverse connected arrangement; a means for receiving a time varying electrical signal, the means for receiving being operatively connected to the anode of each of the first LED of the plurality of LED pairs; and a plurality of means for driving an LED, each of the plurality of driving means being associated with a particular one of the plurality of LED pairs and being controllable to one of a high value and a low value, the output of each of the plurality of driving means being operatively connected to the cathode of the first LED of the associated particular one of the plurality of LED pairs, wherein the received time varying electrical signal exhibits a high value operative to illuminate the first LED of each of the plurality of LED pairs when the driving means associated with the LED pair exhibits a low value, and a low value operative to illuminate the second LED of each of the plurality of LED pairs when the driving means associated with the LED pair exhibits a high value.

In one embodiment each of the driving means comprises a tri-state buffer further exhibiting a high impedance output state, neither the first LED nor the second LED of the LED pair associated with the tri-state buffer being illuminated when the tri-state buffer exhibits a high impedance output state. In another embodiment the apparatus further comprises a source of the received time varying electrical signal operatively connected to the means for receiving. Preferably the source comprises one of a square wave generator, a sine wave generator and a saw-tooth wave generator. In one further embodiment the source outputs the time varying signal, and the time varying signal is periodic.

In one embodiment the driving means comprises at least one register, in another embodiment the driving means comprises a buffer and in yet another embodiment the driving means comprises a controller.

In one embodiment the plurality of driving means comprises: a controller; at least one register responsive to the controller; and a plurality of tri-state buffers, each of the plurality of tri-state buffers being operatively connected to a unique output of the at least one register, each of the plurality of driving means comprising a unique tri-state buffer of the plurality of tri-state buffers.

In an exemplary embodiment each of the LED pairs is enclosed in a bi-color LED assembly.

The invention also provides for an apparatus for driving a plurality of LED pairs, the apparatus comprising: a plurality of LED pairs, each of the plurality of LED pairs exhibiting a first LED and a second LED in a parallel reverse connected arrangement; a source of a time varying signal operatively connected to the anode of each of the first LED of the plurality of LED pairs, the time varying signal exhibiting a high value and a low value; and a plurality of LED drivers, each of the plurality of LED drivers being associated with a particular one of the plurality of LED pairs and being controllable to one of a high value and a low value, the output of each of the plurality of LED drivers being operatively connected to the cathode of the first LED of the associated particular one of the plurality of LED pairs, wherein the high value of the time varying signal is sufficient to illuminate the first LED of each of the plurality of LED pairs when the LED driver associated with the LED pair exhibits a low value, and the low value of the time varying signal is operative to illuminate the second LED of each of the plurality of LED pairs when the LED driver associated with the LED pair exhibits a high value.

In one embodiment the source of the time varying signal comprises one of a square wave generator, a sine wave generator and a saw-tooth wave generator and in another embodiment the time varying signal is periodic.

In one embodiment the plurality of LED drivers comprises at least one register and in another embodiment the plurality of LED drivers comprises a controller. In another embodiment the plurality of LED drivers comprises a controller; at least one register responsive to the controller; and a plurality of tri-state buffers, each of the plurality of tri-state buffers being operatively connected to a unique output of the at least one register, each of the plurality of LED drivers comprising a unique tri-state buffer of the plurality of tri-state buffers.

In an exemplary embodiment each of the LED pairs is enclosed in a bi-color LED assembly.

The invention also provides for a method of driving bi-color LED assemblies, the method comprising: providing a plurality of LED pairs each of the provided plurality of LED pairs exhibiting a first LED and a second LED in a parallel reverse connected arrangement; receiving a time varying electrical signal commonly at the anode of the first LED of each of the provided plurality of LED pairs, the time varying electrical signal exhibiting a high value and a low value; and individually driving the cathode of the first LED of each output of each of the provided plurality of LED pairs to one of a high value and a low value, wherein the high value of the received time varying electrical signal is operative to illuminate the first LED of each of the plurality of LED pairs when the cathode of the first LED is driven to a low level, and the low value of the received time varying electrical signal is operative to illuminate the second LED of each of the plurality of LED pairs when the cathode of the first LED is driven to a high level.

In one embodiment the method further comprises providing a source of the received time varying electrical signal. In another embodiment the received time varying signal is one of a square wave, a sine wave and a saw-tooth wave and in another embodiment the received time varying signal is periodic.

In one embodiment the method further comprises: providing at least one register, the individually driving being responsive to the provided at least one register. In another embodiment the method further comprises providing a controller, the individually driving being responsive to the provided controller.

In one embodiment the method further comprises providing a controller; and providing at least one register responsive to the controller, the individually driving being responsive to an output of the provided at least one register.

In one embodiment the method further comprises providing a plurality of tri-state buffers, each of the tri-state buffers being associated with a unique one of the provided plurality of LED pairs; and setting the tri-state buffer to a high impedance output state, neither the first LED nor the second LED being illuminated responsive to the high impedance output state.

In an exemplary embodiment each of the provided LED pairs are is enclosed in a bi-color LED assembly.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a high level block diagram of a first embodiment of a system for supporting a plurality of LED pairs, illustrated as bi-color LED assemblies, in accordance with the principle of the current invention, in which the number of connections between a driving circuit and the plurality of bi-color LED assemblies is on the order of the number of bi-color LED assemblies to be driven, and in particular is one more than the number of bi-color LED assemblies;

FIG. 2 is a high level block diagram of a second embodiment of a system for supporting a plurality of LED pairs, illustrated as bi-color LED assemblies, in accordance with the principle of the current invention, in which the number of connections between a driving circuit and the plurality of bi-color LED assemblies is on the order of the number of bi-color LED assemblies to be driven, and in particular is one more than the number of bi-color LED assemblies; and

FIG. 3 is a high level flow chart of the operation of the controller of FIG. 1 or FIG. 2 to light a specific color LED of a specific bi-color LED assembly in accordance with the principle of the current invention.

### DETAILED DESCRIPTION OF PREFERRED EMBODIMENTS

The present embodiments enable a circuit for controllably illuminating a plurality of parallel reverse connected LED pairs via a single specific connection associated with each LED pair plus a single common connection for all of the LED pairs. The single common connection is connected to a source of a time varying signal, preferably a slew controlled square wave. Each single specific connection is connected to a controllable source, such as a digital TTL level output, which can be controllably set to one of a high level and a low level. Preferably the controllable source further exhibits a high impedance output. The invention is being illustrated in connection with parallel reverse connected LED pairs constituted of bi-color LED assemblies, however this is not meant to be limiting in any way.

In the event the output of the controllable source associated with a specific bi-color LED assembly exhibits a low level signal, current is sunk by the controllable source when the time varying signal is high, thereby illuminating a first LED of the bi-color LED assembly. In the event that the output of the controllable source associated with a specific bi-color LED assembly exhibits a high level signal, current is sourced by the controllable source when the time varying signal is low, thereby illuminating the second LED of the bi-color LED assembly. In the event that the output of the controllable source associated with a specific bi-color LED assembly is set to a high impedance state, neither LED of the bi-color LED assembly is illuminated.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

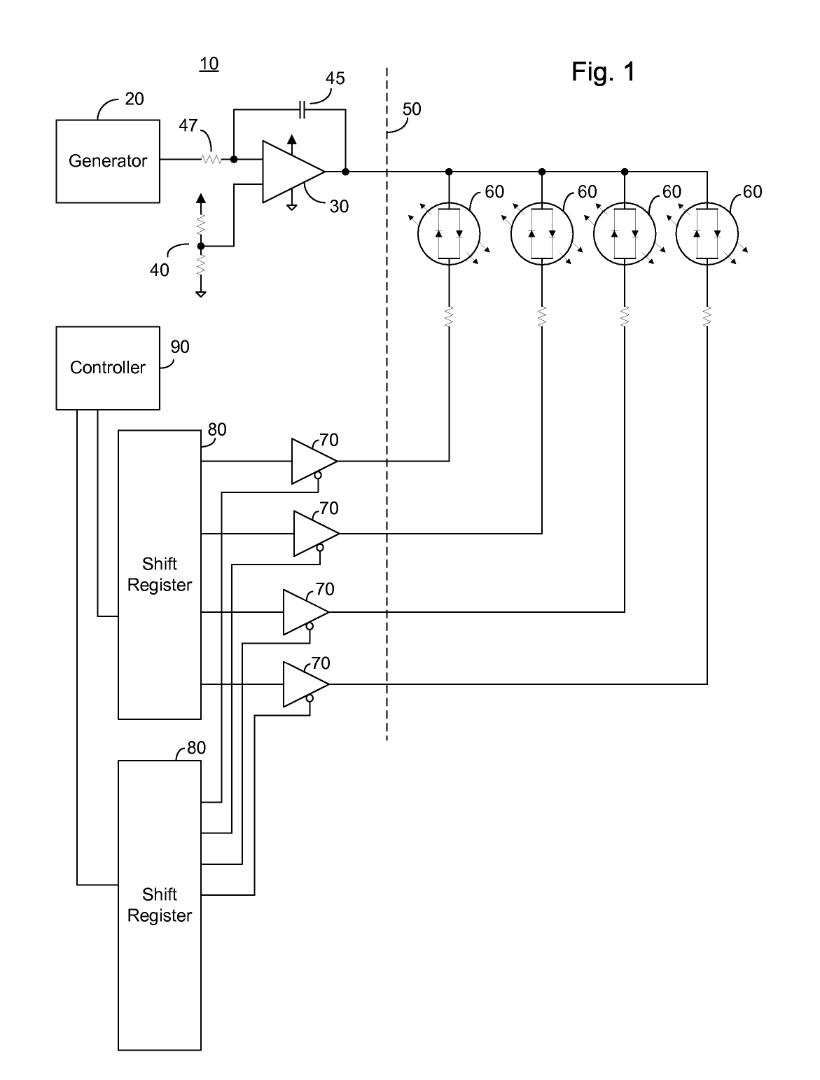

FIG. 1 is a high level block diagram of a system 10 for supporting a plurality of LED pairs, illustrated as bi-color LED assemblies 60, in accordance with the principle of the current invention, in which the number of connections between a driving circuit and the bi-color LED assemblies is on the order of the number of bi-color LED assemblies 60 to be driven, and in particular is one more than the number of bi-color LED assemblies 60. System 10 comprises: a generator 20; a buffer 30; a buffer offset voltage divider 40; a feedback capacitor 45; an input resistor 47; a plurality of bi-color LED assemblies 60; a plurality of tri-state buffers 70; a first and a second shift register 80; and a controller 90. The plurality of bi-color LED assemblies 60 may be remotely located from either buffer 30 and/or tri-state buffers 70, as indicated by a location divider 50 without exceeding the scope of the invention. Thus, divider 50 may represent connectors and cables as required. Each bi-color LED assembly 60 comprises a first LED and a second LED in a parallel reverse connected arrangement, in which the anode of the first LED is connected to the cathode of the second LED and the cathode of the first LED is connected to the anode of the second LED.

The output of generator 20 is connected to the positive input of buffer 30 via input resistor 47, and the output of buffer 30 is commonly connected to a first lead of each bi-color LED assembly 60. Feedback capacitor 45 is connected to feedback a portion of the output of buffer 30 to the positive input lead. Buffer offset voltage divider 40 is connected to allow for the setting of the offset of buffer 30 by setting a reference voltage at the negative input lead of buffer 30. A second lead of each bi-color LED assembly 60 is connected to the output of a particular one of the plurality of tri-state buffers 70 via a respective current limiting resistor. A single tri-state buffer 70 is preferably associated with each bi-color LED assembly 60. The input of each tri-state buffer 70 is connected to a particular output of first shift register 80, and the tri-state input of each tri-state buffer 70 is connected to a particular output of second shift register 80. An output of controller 90 is connected to the input of each of first shift register 80 and second shift register 80.

Controller 90 may comprise a state machine or a micro-controller without exceeding the scope of the invention. Generator 20 may comprise one of a square wave generator, a sine wave generator, a saw tooth generator or other time varying periodic waveform, without exceeding the scope of the invention. The combination of buffer 30, input resistor 47, feedback capacitor 45 and voltage divider 40 functions as an integrator. It is to be understood that in the event generator 20 is constituted of a sine wave or saw tooth generator, buffer 30 is preferably arranged as a buffer. First and second shift registers 80 are illustrated for ease of design by minimizing the number of pins from controller 90 which are required, however their use is optional. In another embodiment (not shown) tri-state buffers 70 are directly connected to outputs of controller 90 without exceeding the scope of the invention. In yet another embodiment (not shown) shift registers 80 are replaced with latching registers having on-board tri-state buffered outputs without exceeding the scope of the invention.

In operation, generator 20 outputs a time varying signal, preferably a periodic time varying signal, and in an exemplary embodiment one of a square wave, a sine wave and a saw-tooth waveform. Buffer 30 receives the time varying signal, shapes and buffers the signal in accordance with the values of input resistor 47, feedback capacitor 45 and voltage divider 40. The output of buffer 30 is set to produce a time varying signal having at least a high value and a low value. The high value of the time varying signal output of buffer 30 is set so that a first LED of each bi-color LED assembly 60 is illuminated during at least a portion of the time varying signal when the output of the respective tri-state buffer 70 is set to a low value. The low value of the time varying signal output of buffer 30 is set so that a second LED of bi-color LED assembly 60 is illuminated when the output of the respective tri-state buffer 70 is set to a high value. The high and low values may be further set so that the luminance levels of the first and second LEDs of each bi-color LED assembly are similar.

Controller 90 is operational via first and second shift registers 80 to set the output of each of tri-state buffers 70 to one of a high value, a low value and a high impedance state. In the event the output of a tri-state buffer 70 is a low value, a first LED of the bi-color LED assembly 60 associated with the tri-state buffer 70 will conduct during the high portion of the time varying signal output by buffer 30 thus producing a light output. A second LED of the bi-color LED assembly will not illuminate. In the event the output of a tri-state buffer 70 is a high level, the second LED of the bi-color LED assembly 60 associated with the tri-state buffer 70 will conduct during the low portion of the time varying signal output by buffer 30 thus producing a light output. The first LED of the bi-color LED assembly will not illuminate. In the event the output of a tri-state buffer 70 is set to a high impedance state neither the first nor the second LED of the bi-color LED assembly 60 will illuminate.

The above has been described in an embodiment utilizing tri-state buffer 70, however this is not meant to be limiting in any way. In another embodiment buffers are utilized that are not tri-state, and in such an embodiment individual bi-color LED assemblies 60 can not be individually turned to a non illuminated condition. Alternatively and additionally, tri-state buffers 70, or non tri-state buffers may be incorporated as part of shift registers 80 or as part of the output of controller 90 without exceeding the scope of the invention.

Additionally and optionally, the output of buffer 30 may be modulated to exhibit a higher or lower value in synchronization with the operation of tri-state buffers 70, thereby enabling brightness control for the LEDs of bi-color LED assemblies 60. Additionally and optionally, buffer 30 may be replaced with a tri-state buffer, or have an additional tri-state buffer attached thereto, thereby enabling a cessation of all illumination by placing buffer 30 into a high impedance state. Generator 30, and/or buffer 30 should be designed with an appropriate DC offset as required. Additionally and optionally, the outputs of tri-state buffers 70 may be switched synchronously with the output of buffer 30, thereby illuminating both first and second LEDs of a specific bi-color LED assembly 60 to generate a mixed color.

In another embodiment (not shown) the output of buffer 30 is connected to additional bi-color LED assemblies 60 via an inverter. Thus, additional bi-color LED assemblies exhibit illumination of the first LED contained therein out of phase with the illumination of the first LEDs of the bi-color LED assemblies described above. Such an arrangement assists in load balancing.

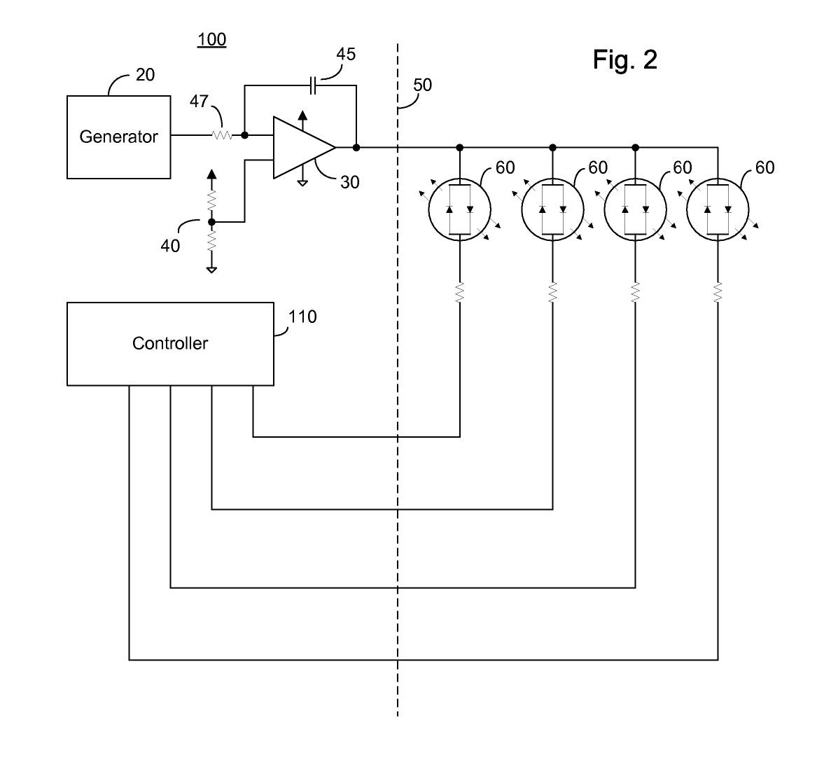

FIG. 2 is a high level block diagram of a system 100 for supporting a plurality of LED pairs, illustrated as bi-color LED assemblies 60, in accordance with the principle of the current invention, in which the number of connections between a driving circuit and the bi-color LED assemblies is on the order of the number of bi-color LED assemblies 60 to be driven, and in particular is one more than the number of bi-color LED assemblies 60. System 10 comprises: a generator 20; a buffer 30; a buffer offset voltage divider 40; a feedback capacitor 45; an input resistor 47; a plurality of bi-color LED assemblies 60; and a controller 110. The plurality of bi-color LED assemblies 60 may be remotely located from either buffer 30 and/or tri-state buffers 70, as indicated by a location divider 50 without exceeding the scope of the invention. Thus, divider 50 may represent connectors and cables as required. Each bi-color LED assembly 60 comprises a first LED and a second LED in a parallel reverse connected arrangement, in which the anode of the first LED is connected to the cathode of the second LED and the cathode of the first LED is connected to the anode of the second LED.

The output of generator 20 is connected to the positive input of buffer 30 via input resistor 47, and the output of buffer 30 is commonly connected to a first lead of each bi-color LED assembly 60. Feedback capacitor 45 is connected to feedback a portion of the output of buffer 30 to the positive input lead. Buffer offset voltage divider 40 is connected to allow for the setting of the offset of buffer 30 by setting a reference voltage at the negative input lead of buffer 30. A second lead of each bi-color LED assembly 60 is connected via a respective current limiting resistor to a particular output of controller 110.

Controller 110 may comprise a state machine or a micro-controller without exceeding the scope of the invention, and exhibits an output having sufficient drive capability to drive the LEDs of the associated bi-color LED assembly 60. Preferably the output is latched and buffered. Further preferably the output is settable to one of a low value, a high value and a high impedance state. Generator 20 may comprise one of a square wave generator, a sine wave generator, a saw tooth generator or other time varying periodic waveform, without exceeding the scope of the invention. The combination of buffer 30, input resistor 47, feedback capacitor 45 and voltage divider 40 functions as an integrator. It is to be understood that in the event generator 20 is constituted of a sine wave or saw tooth generator, buffer 30 is preferably arranged as a buffer.

In operation, generator 20 outputs a time varying signal, preferably a periodic time varying signal, and in an exemplary embodiment one of a square wave, a sine wave and a saw-tooth waveform. Buffer 30 receives the time varying signal, shapes and buffers the signal in accordance with the values of input resistor 47, feedback capacitor 45 and voltage divider 40. The output of buffer 30 is set to produce a time varying signal having at least a high value and a low value. The high value of the time varying signal output of buffer 30 is set so that a first LED of each bi-color LED assembly 60 is illuminated during at least a portion of the time varying signal when the respective output of controller 110 is set to a low value. The low value of the time varying signal output of buffer 30 is set so that a second LED of bi-color LED assembly 60 is illuminated when the respective output of controller 110 is set to a high value. The high and low values may be further set so that the luminance levels of the first and second LEDs of each bi-color LED assembly are similar.

In the event the respective output of controller 110 is a low value, a first LED of the bi-color LED assembly 60 associated therewith will conduct during the high portion of the time varying signal output by buffer 30 thus producing a light output. A second LED of the bi-color LED assembly will not illuminate. In the event the respective output of controller 110 is a high level, the second LED of the bi-color LED assembly 60 associated with the tri-state buffer 70 will conduct during the low portion of the time varying signal output by buffer 30 thus producing a light output. The first LED of the bi-color LED assembly will not illuminate. In the event the respective output of controller 110 is set to a high impedance state neither the first nor the second LED of the bi-color LED assembly 60 will illuminate.

The above has been described in an embodiment in which the respective outputs of controller 110 may be set to a high impedance state, i.e. they represent tri-state outputs, however this is not meant to be limiting in any way. In another embodiment the respective outputs of controller 110 are not tri-state outputs, and in such an embodiment individual bi-color LED assemblies 60 can be individually turned to a non-illuminated condition by changing a respective output of controller 110 in synchronization with the output of buffer 30.

Additionally and optionally, the output of buffer 30 may be modulated to exhibit a higher or lower value in synchronization with the operation of the outputs of controller 110, thereby enabling brightness control for the LEDs of bi-color LED assemblies 60. Additionally and optionally, buffer 30 may be replaced with a tri-state buffer, or have an additional tri-state buffer attached thereto, thereby enabling a cessation of all illumination by placing buffer 30 into a high impedance state. Generator 30, and/or buffer 30 should be designed with an appropriate DC offset as required. Additionally and optionally, the outputs of controller 110 may be switched synchronously with the output of buffer 30, thereby illuminating both first and second LEDs of a specific bi-color LED assembly 60 to generate a mixed color.

In another embodiment (not shown) the output of buffer 30 is connected to additional bi-color LED assemblies 60 via an inverter. Thus, additional bi-color LED assemblies exhibit illumination of the first LED contained therein out of phase with the illumination of the first LEDs of the bi-color LED assemblies described above. Such an arrangement assists in load balancing.

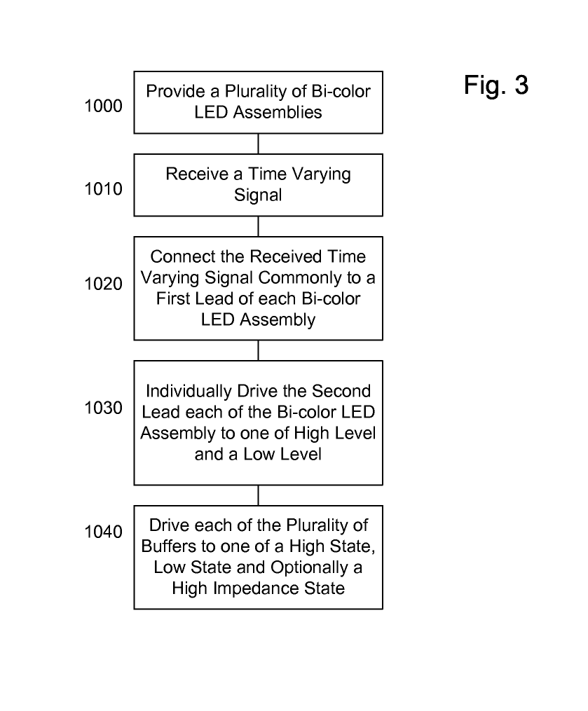

FIG. 3 is a high level flow chart of the operation of controller 90 of FIG. 1 and controller 110 of FIG. 2 to light a specific color LED of a specific bi-color LED assembly in accordance with the principle of the current invention. In stage 1000, a plurality of bi-color LED assemblies are provided, preferably each bi-color LED assembly comprising a pair of LEDs in a parallel reverse connected arrangement.

In stage 1010, a time varying signal is received. Preferably the time varying signal is periodic, and is further preferably one of a square wave, a sine wave and a saw tooth waveform. The time varying signal exhibits at least a high value and a low value. The high value of the received time varying signal is of a value such that a first LED of each bi-color LED assembly 60 is illuminated during at least a portion of the time varying signal when the output of the respective buffer or controller is set to a low value. The low value of the received time varying signal is of a value such that a second LED of bi-color LED assembly 60 is illuminated when the output of the respective buffer or controller is set to a high value. The high and low values may be further set so that the luminance levels of the first and second LEDs of each bi-color LED assembly are similar.

In stage 1020, the received time varying signal of stage 1010 is connected commonly to a first lead of each of the plurality of bi-color LED assemblies provided in stage 1000.

In stage 1030, the second lead of each of the plurality of bi-color LED assemblies provided in stage 1000 is driven in accordance with the desired illumination condition of the bi-color LED assembly. Thus, in the event a first color LED of a particular bi-color LED assembly is to be illuminated, a low value output is set to the respective associated buffer or controller output, and in the event a second color LED of a particular bi-color LED assembly is to be illuminated, a high value output is set to the respective associated buffer or controller output. Optionally, the respective buffers or controller output exhibit tri-state outputs, and thus in the event neither LED of the associated bi-color LED assembly is to be illuminated, the output of the respective associated buffer or controller is set to a high impedance state.

Thus, the present embodiments enable a circuit for controllably illuminating a plurality of parallel reverse connected LED pairs via a single specific connection associated with each LED pair plus a single common connection for all of the LED pairs. The single common connection is connected to a source of a time varying signal, preferably a slew controlled square wave. Each single specific connection is connected to a controllable source, such as a digital TTL level output, which can be controllably set to one of a high level and a low level. Preferably the controllable source further exhibits a high impedance output. The invention is being illustrated in connection with parallel reverse connected LED pairs constituted of bi-color LED assemblies, however this is not meant to be limiting in any way.

In the event the output of the controllable source associated with a specific bi-color LED assembly exhibits a low level signal, current is sunk by the controllable source when the time varying signal is high, thereby illuminating a first LED of the bi-color LED assembly. In the event that the output of the controllable source associated with a specific bi-color LED assembly exhibits a high level signal, current is sourced by the controllable source when the time varying signal is low, thereby illuminating the second LED of the bi-color LED assembly. In the event that the output of the controllable source associated with a specific bi-color LED assembly is set to a high impedance state, neither LED of the bi-color LED assembly is illuminated.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description and which are not in the prior art.

I claim:

1. An apparatus for driving a plurality of LED pairs, the apparatus comprising:
a plurality of LED pairs, each of said plurality of LED pairs exhibiting a first LED and a second LED in a parallel reverse connected arrangement;
a means for receiving a time varying electrical signal, said means for receiving being operatively connected to the anode of each of the first LED of said plurality of LED pairs; and
a plurality of means for driving an LED, each of said plurality of driving means being associated with a particular one of said plurality of LED pairs and being controllable to one of a high value and a low value, the output of each of said plurality of driving means being operatively connected to the cathode of the first LED of said associated particular one of said plurality of LED pairs,
wherein said received time varying electrical signal exhibits a high value operative to illuminate the first LED of each of said plurality of LED pairs when said driving means associated with said LED pair exhibits a low value, and a low value operative to illuminate the second LED of each of said plurality of LED pairs when said driving means associated with said LED pair exhibits a high value.

2. An apparatus according to claim 1, wherein each of said driving means comprises a tri-state buffer further exhibiting a high impedance output state, neither the first LED nor the second LED of said LED pair associated with said tri-state buffer being illuminated when said tri-state buffer exhibits a high impedance output state.

3. An apparatus according to claim 1, further comprising a source of said received time varying electrical signal operatively connected to said means for receiving.

4. An apparatus according to claim 3, wherein said source comprises one of a square wave generator, a sine wave generator and a saw-tooth wave generator.

5. An apparatus according to claim 3, wherein said source outputs said time varying signal, and said time varying signal is periodic.

6. An apparatus according to claim 1, wherein said driving means comprises at least one register.

7. An apparatus according to claim 1, wherein said driving means comprises a buffer.

8. An apparatus according to claim 1, wherein said driving means comprises a controller.

9. An apparatus according to claim 1, wherein said plurality of driving means comprises:
a controller;
at least one register responsive to said controller; and
a plurality of tri-state buffers, each of said plurality of tri-state buffers being operatively connected to a unique output of said at least one register, each of said plurality of driving means comprising a unique tri-state buffer of said plurality of tri-state buffers.

10. An apparatus according to claim 1, wherein each of said LED pairs is enclosed in a bi-color LED assembly.

11. An apparatus for driving a plurality of LED pairs, the apparatus comprising:
a plurality of LED pairs, each of said plurality of LED pairs exhibiting a first LED and a second LED in a parallel reverse connected arrangement;
a source of a time varying signal operatively connected to the anode of each of the first LED of said plurality of LED pairs, said time varying signal exhibiting a high value and a low value; and
a plurality of LED drivers, each of said plurality of LED drivers being associated with a particular one of said plurality of LED pairs and being controllable to one of a high value and a low value, the output of each of said plurality of LED drivers being operatively connected to the cathode of the first LED of said associated particular one of said plurality of LED pairs,
wherein said high value of said time varying signal is sufficient to illuminate the first LED of each of said plurality of LED pairs when said LED driver associated with said LED pair exhibits a low value, and said low value of said time varying signal is operative to illuminate the second LED of each of said plurality of LED pairs when said LED driver associated with said LED pair exhibits a high value.

12. An apparatus according to claim 11, wherein said source of the time varying signal comprises one of a square wave generator, a sine wave generator and a saw-tooth wave generator.

13. An apparatus according to claim 11, wherein said time varying signal is periodic.

14. An apparatus according to claim 11, wherein said plurality of LED drivers comprises at least one register.

15. An apparatus according to claim 11, wherein said plurality of LED drivers comprises a controller.

16. An apparatus according to claim 11, wherein said plurality of LED drivers comprises:
a controller;
at least one register responsive to said controller; and
a plurality of tri-state buffers, each of said plurality of tri-state buffers being operatively connected to a unique output of said at least one register, each of said plurality of LED drivers comprising a unique tri-state buffer of said plurality of tri-state buffers.

17. An apparatus according to claim 11, wherein each of said LED pairs is enclosed in a bi-color LED assembly.

18. A method of driving bi-color LED assemblies, the method comprising:
providing a plurality of LED pairs each of said provided plurality of LED pairs exhibiting a first LED and a second LED in a parallel reverse connected arrangement;
receiving a time varying electrical signal commonly at the anode of the first LED of each of said provided plurality of LED pairs, said time varying electrical signal exhibiting a high value and a low value; and
individually driving the cathode of the first LED of each output of each of said provided plurality of LED pairs to one of a high value and a low value,
wherein said high value of said received time varying electrical signal is operative to illuminate the first LED of each of said plurality of LED pairs when said cathode of said first LED is driven to a low level, and said low value of said received time varying electrical signal is operative to illuminate the second LED of each of said plurality of LED pairs when said cathode of said first LED is driven to a high level.

19. A method according to claim 18, further comprising:
providing a source of said received time varying electrical signal.

20. A method according to claim 18, wherein said received time varying signal is one of a square wave, a sine wave and a saw-tooth wave.

21. A method according to claim 18, wherein said received time varying signal is periodic.

22. A method according to claim 18, further comprising:
providing at least one register,
said individually driving being responsive to said provided at least one register.

23. A method according to claim 18, further comprising:
providing a controller,
said individually driving being responsive to said provided controller.

24. A method according to claim 18, further comprising:
providing a controller; and
providing at least one register responsive to said controller,
said individually driving being responsive to an output of said provided at least one register.

25. A method according to claim 18, further comprising:
providing a plurality of tri-state buffers, each of said tri-state buffers being associated with a unique one of said provided plurality of LED pairs; and
setting said tri-state buffer to a high impedance output state,
neither said first LED nor said second LED being illuminated responsive to said high impedance output state.

26. A method according to claim 18, wherein each of said provided LED pairs is enclosed in a bi-color LED assembly.
